(19) United States
(12) Patent Application Publication
(10) Pub. No.: US 2012/0128932 A1
(43) Pub. Date: May 24, 2012

(54) Structured Surfaces for Implants

(76) Inventors: Michael Veith, St.-Ingbert (DE); Oral Cenk Aktas, Saarbruecken (DE); Martin Oberringer, Neunkirchen (DE); Wolfgang Metzger, Saarbruecken (DE)

(21) Appl. No.: 13/387,394

(22) PCT Filed: Jul. 6, 2010
(86) PCT No.: PCT/EP2010/004075

§ 371 Date: Jan. 27, 2012

(30) Foreign Application Priority Data
Jul. 31, 2009 (DE) 10 2009 035 795.5

(51) Int. Cl. B32B 3/00; B05D 3/06; B05D 5/00

(52) U.S. Cl. 428/141; 427/532; 427/553

(57) ABSTRACT

The use of a structured coating for implants, particularly for endoprostheses, and a method for production of the coating are provided. At least one metal-organic compound of the general formula El(OR)H₂, wherein R stands for an aliphatic or alicyclic hydrocarbon radical and El stands for Al, Ga, In or Tl, first disintegrates at a temperature of more than 400° C., forming a composite structure on the substrate, and is then irradiated, forming a structured coating having a microstructure and/or a nanostructure.

### FIELD OF INVENTION

The invention relates to the use of a structured coating for implants, in particular for endoprostheses, and a method for production of such a coating.

### STATE OF THE ART

A still unsolved problem with implants, in particular of endoprostheses, is aseptic prosthesis loosening. As a result of this, ca. 10% of all implants have to be examined afresh or adjusted within the first 15 years.

This complication normally begins with reduced adhesion of osteoblasts to the implant surface. This leads to encapsulation of the implant, often associated with the formation of a cavity filled with fluid. This favors the prosthesis detachment, since the regeneration of the tissue is still further prevented. Also, the encapsulation is favored by the adhesion of fibroblasts to the implant surface.

In contrast to this, the so-called osseointegration describes the ideal reaction of the surrounding bone with the implant, i.e. a direct bonding of the newly formed bone with the surface of the implant without a soft tissue layer.

As materials for clinical applications, titanium, titanium alloys, but also ceramic materials such as aluminum oxide or zirconium oxide are used. Here in particular aluminum oxide exhibits good biocompatibility.

However, apart from the material of the surface, the surface structure of the implant has a decisive role. Here it is known that structures in the micrometer range, but also in the nanometer range, favor the adhesion of osteoblasts as opposed to the adhesion of fibroblasts. This is also decisively determined by the material used, and its surface topography and its roughness and porosity. Here a structuring in the micrometer range is advantageous (Jager M, Zilkens C, Zanger K, Krauspe R. Significance of nano- and microtopography for cell-surface interactions in orthopaedic implants. J Biomed Biotechnol 2007(8); 69036; Hulbert S F, Young F A, Mathews R S, Klawitter J J, Talbert C D, Stelling F H. Potential of ceramic materials as permanently implantable skeletal prostheses. J Biomed Mater Res 1970; 4(3): 433-456).

In several studies, good compatibility of aluminum oxide, in particular of nanoporous membranes with a pore diameter of 30-80 nm, has been demonstrated (Webster T, Hellenmeyer E, Price R. Increased osteo-blast functions on theta plus delta nanofiber alumina. Biomaterials 2005; 26(9): 953-960; Swan E, Popat K, Grimes C, Desai T. Fabrication and evaluation of nanoporous alumina membranes for osteoblast culture. Journal of Biomedical Materials Research Part A 2005; 72A(3): 288-295).

From the applicant's document WO 2008/011920 A1, nanowires, or a one-dimensional composite structure consisting of a metallic core and coated with a metal oxide, in particular made of aluminum and aluminum oxide, are known.

However, the ideal material and the ideal surface structure are still far from having been found. Also, the studies often show contradictory results as regards the required properties of the surface. Thus the cell type also decisively determines the compatibility. Hence it is also of great importance that the structure of a surface can be structured and adapted in a simple manner.

### OBJECTIVE

The objective of the invention is to provide a structured coating which remedies said disadvantages of the state of the art and is suitable for use as a coating of implants, in particular endoprostheses. In addition, a method for the production of such coatings is to be provided.

### SOLUTION

This problem is solved through the inventions with the features of the independent claims. Advantageous further developments of the inventions are characterized in the subclaims. The wording of all the claims is hereby by reference incorporated in the content of this description. The invention also includes all reasonable and in particular all mentioned combinations of independent and/or dependent claims.

The problem is solved through the use of a structured coating for the coating of implants, wherein the structured coating consists of at least one oxide selected from aluminum oxide, gallium oxide, indium oxide and thallium oxide and has a microstructure and/or a nanostructure, preferably of aluminum oxide.

Here a microstructure is understood to mean a structure which has at least one dimension which is smaller than one millimeter but greater than one micrometer. Correspondingly, nanostructures have at least one dimension which is smaller than one micrometer.

The structuring is in particular located on the surface of the coating.

It has surprisingly been found that such a coating has especially advantageous properties for use in implants. Thus the adhesion of fibroblasts is markedly reduced.

The coating advantageously has a microstructure in the range (order of magnitude) from 1 to 100 μm, preferably between 1 and 10 μm, especially preferably between 1 and 6 μm, and in particular between 3 and 5 μm.

The coating according to the invention can also include the metal and the corresponding metal oxide. Here, the metal oxide forms at least the surface of the coating, while the metal is not located on the surface.

In a preferred embodiment of the invention, the coating comprises a one-dimensional composite structure of a metal and a metal oxide, wherein the metal is selected from the group containing Al, Ga, In or Tl. Here a one-dimensional composite structure is a composite of a metallic core and a metal oxide covering. The one-dimensional composite structure can include one or more nanowires of the structure described or consist thereof. Alternatively, as well as these simple, linear, cable-like, one-dimensional structures, the one-dimensional structure can additionally include one or more branched structures or consist thereof, which are built up of several nanowires of the linear shape grown on one another like branches. These two shapes can also be described as linear and branched nanowires respectively. In the branched shape, the metallic cores of the wires can be in contact at the branchings or the metallic cores can be separated from one another by the metal oxide covering at the branchings. The one-dimensional composite structure can be present free or be situated on a substrate. A one-dimensional composite structure of aluminum and aluminum oxide is preferred.

The nanowires have in particular two dimensions which lie in the range below 200 nm, e.g. in the range from 1 to 200 nm and preferably from 10 to 100 nm, in particular about 20 to 40 nm. The ratio of breadth to length of the nanowires is generally at least 1:3 and preferably at least 1:5. The third dimension as a rule lies in the micrometer and sub-micrometer range. As a rule, the cross-section of the nanowires is approximately circular.

Nanowires such as are already known from WO 2008011920 A1 are preferred, whereby reference is explicitly made to the content of this document.

In one embodiment, the coating has a contact angle (or wetting angle) of less than 40°, preferably less than 20°, with water as the measurement liquid.

In a further embodiment, the coating has a quadratic roughness of greater than 5 μm, preferably between 5 μm and 10 μm.

In a further preferred embodiment, the structured coating is obtained by irradiation of the one-dimensional composite structure, preferably by irradiation with a laser. The one-dimensional composite structure is preferably a broad band absorber and hence can absorb light from a wide wavelength range. The wavelength of the laser can lie in the range from UV to electro-magnetic waves, preferably in the range from 300 nm to 15 μm, especially preferably in the range from 500 nm to 11 μm, and still more advantageously but not limited to, lasers with the wavelengths 488 nm, 514 nm, 532 nm, 635 nm, 1064 nm or 10.6 μm. Wavelengths from a range of 500 nm to 700 nm, preferably between 500 nm and 600 nm, are preferred. Continuous (CW) or pulsed lasers can be used. Pulsed lasers are preferably used.

During the irradiation, the metal of the one-dimensional component can be completely converted into the metal oxide.

Preferably, depending on the wavelength used and the element/element oxide structure, the laser energy used lies between 1 milliwatt per square centimeter and several watts per square centimeter, preferably between 1 milliwatt per square centimeter and 10 watts per square centimeter, and especially preferably between 1 mW/cm² and 5 W/cm².

Through the irradiation, the one-dimensional composite structure is heated locally. As a result, there is not only oxidation of the metal, in particular when the irradiation is performed in the presence of oxygen, e.g. under ambient air, but also local melting of the one-dimensional composite structure. On solidification, the nanoscale structure of the composite structure at least partly breaks down and larger structures of the order of micrometer size, for example between 1 to 5 μm, are formed. Controlled by the intensity of the laser and/or the frequency and/or length of the laser pulses, surface structures modified in a great variety of ways, such as for example structures which contain both nanostructures and also microstructures, can be created. In this way, the coating can be adapted in a simple manner.

Thus it has been found that both one-dimensional composite structures and also irradiated one-dimensional composite structures display markedly lower adhesion of fibroblasts, in particular with irradiation with higher intensity, or several laser pulses. Thus the adhesion of fibroblasts seems to be reduced both with the nanostructure of the one-dimensional composite structure, and also with the microstructure of the surface after irradiation. This can also be discerned in that fibroblasts form only a few or no filopodia for adhesion and a markedly reduced cell density is measured on culturing on these coatings. Also seen is a marked decrease in proliferation, or the number of mitotic cells, in particular with the more strongly irradiated coatings.

At the same time, with the use of aluminum oxide even with use of the one-dimensional structure, which also contains pure aluminum, no Al³⁺ ions could be detected in the medium of the cells. This demonstrates the good biocompatibility of such coatings.

In addition, this effect of the irradiation of the one-dimensional composite structure can be restricted to the surface. Thus, the penetration depth of the laser can for example with the use of a pulsed laser be reduced to a range of less than ca. 400 nm, preferably less than ca. 300 nm, especially preferably less than ca. 200 nm. This enables not only the production of very thin layers, but also particularly gentle treatment of the substrate, and the maintenance of the nanostructure below the surface and for example within pores, which can also be several micrometers in size.

The coating according to the invention can be used for the coating of a great variety of implants and endo-prostheses. Thus the invention, particularly through the simple control of the surface topography of the coating, enables simple adaptation to any conditions. For example, tooth implants, parts for artificial joints or bone screws are possible.

In addition, the invention relates to a method for the production of a structured coating on a substrate. Individual process steps are described in more detail below. The steps do not necessarily have to be carried out in the stated order, and the method to be described can also include other steps, not mentioned.

Firstly, a one-dimensional composite structure on the substrate is obtained by thermolytic decomposition of at least one organometallic compound of the general formula El(OR)H₂, wherein R stands for an aliphatic or alicyclic hydrocarbon residue and El for Al, Ga, In or Tl, at a temperature of more than 400° C. El preferably stands for aluminum.

The thermolytic decomposition is preferably a decomposition in a CVD apparatus. Appropriate process conditions are known for example from the applicant's WO 2008/011920 A1.

As substrates, all substrates which are suitable for the conditions of the thermolytic decomposition on their surface can be used. Advantageously, the substrate is a metal or a metal alloy or a ceramic. However, plastics can also be used, if these withstand the conditions of the thermolytic decomposition. In particular, the materials used for implants and endo-prostheses, such as stainless steel, cobalt-chromium alloys, pure titanium or titanium alloys, can be used.

In a further step, the resulting composite structure is irradiated. Suitable conditions have already been described regarding the use of the composite structure. In particular, the composite structure is irradiated with formation of micro- and/or nanostructures.

In a preferred embodiment, the composite structure is irradiated with a pulsed light source, in particular with a pulsed laser. Here such a pulse can for example be between 1 to 100 nsecs long, preferably less than 50 nsecs, especially preferably less than 20 nsecs or 10 nsecs. The pulse frequency lies between 1 Hz and 100 Hz, preferably between 5 Hz and 50 Hz.

The number of pulses is preferably less than 10, especially preferably less than 7 pulses, especially preferably between 3 and 5 pulses.

Depending on the fluence of the irradiation, a different number of pulses may be necessary in order to create a certain surface structure. The fluence can lie between 0.01 J/cm² and 2 J/cm², preferably between 0.1 J/cm² and 0.5 J/cm², especially preferably between 0.1 and 0.3 J/cm².

Particularly with irradiation with more than 2 pulses, the surface topography of the coating changes very markedly. The one-dimensional composite structure melts and probably due to the ablation pressure spherical bulges are formed on the surface. The density and location of these structures can be controlled through the intensity of the laser.

The invention further relates to a structured coating, in particular for implants and/or endoprostheses, of an oxide selected from aluminum oxide, gallium oxide, indium oxide and thallium oxide. The coating has a microstructure in the range from 1 to 100 μm, preferably between 1 and 10 μm, especially preferably between 1 and 6 μm, and in particular between 3 and 5 μm.

The coating according to the invention can also contain the metal oxide and the corresponding metal. Here the metal oxide forms at least the surface of the coating, while the metal is not located on the surface. Aluminum is preferred as the metal and aluminum oxide as the metal oxide.

Further properties of the coating according to the invention have already been described above.

In a further embodiment, the coating is obtainable by the method according to the invention.

The coating of the invention can also have other features in order further to improve the properties. Thus for example further coatings can be applied to increase the biocompatibility. Growth factors to favor bone growth can also be bonded or absorbed onto the surface, e.g. bone morphogenic protein I.

Further properties and features follow from the following description of preferred practical examples in conjunction with the subclaims. In these, the features concerned can be implemented for themselves alone or as several in combination with one another. The possibilities for solving the problem are not restricted to the practical examples. Thus for example range statements always include all, not mentioned, intermediate values and all possible component intervals.

The practical examples are presented diagrammatically in the figures. Specifically, these show:

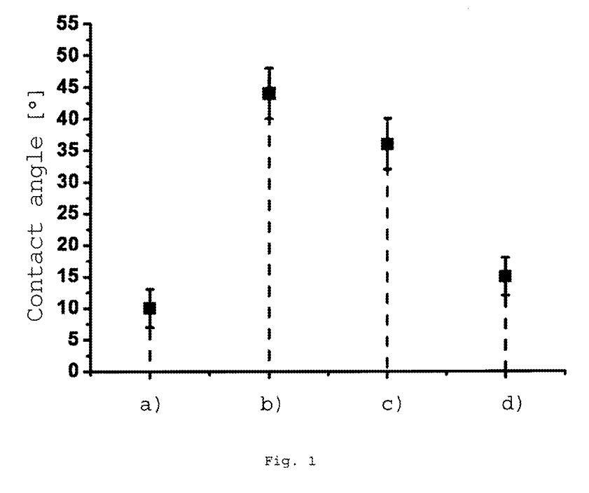

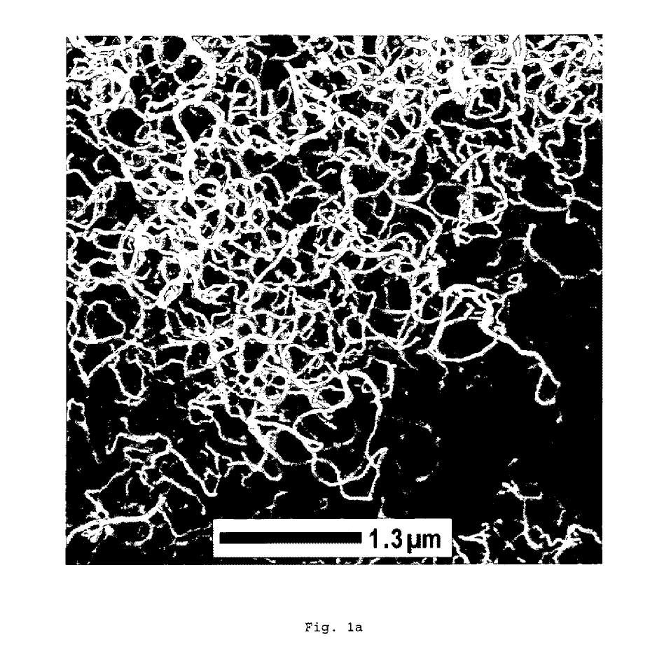

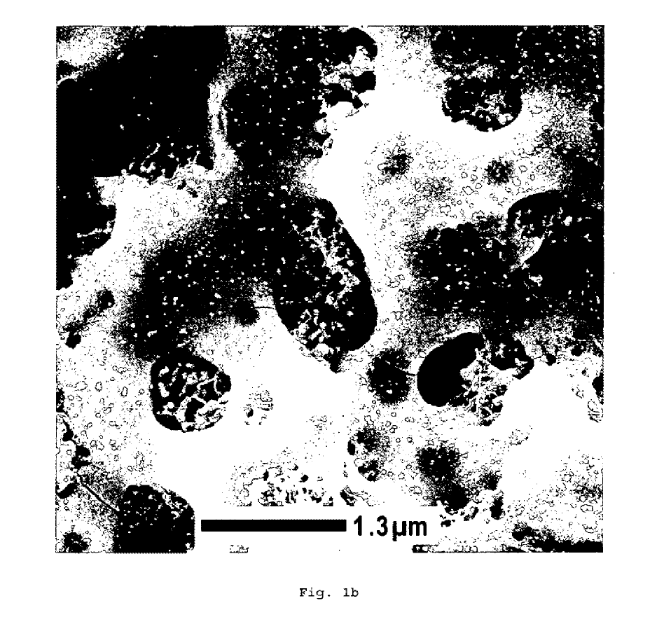

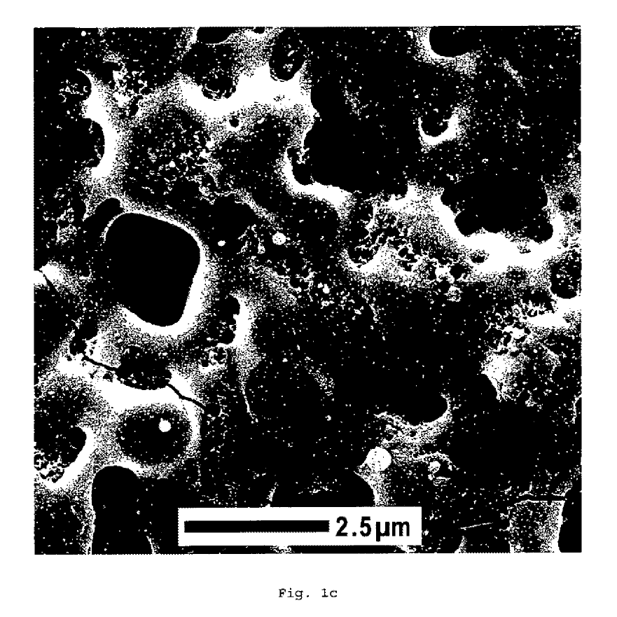

FIG. 1 Contact angle of a one-dimensional composite structure of Al/Al₂O₃ without irradiation (a), after irradiation with one laser pulse (b), with two laser pulses (c) and with three laser pulses (d); the SEM photos (SEM: scanning electron microscope) show the respective surfaces without irradiation (a, scale: 1.3 μm), after irradiation with one laser pulse (b, scale: 1.3 μm), with two laser pulses (c, scale: 2.5 μm) and with three laser pulses (d, scale 2.5 μm);

FIG. 2 XPS spectrum of a one-dimensional composite structure of Al/Al₂O₃ after irradiation with one laser pulse;

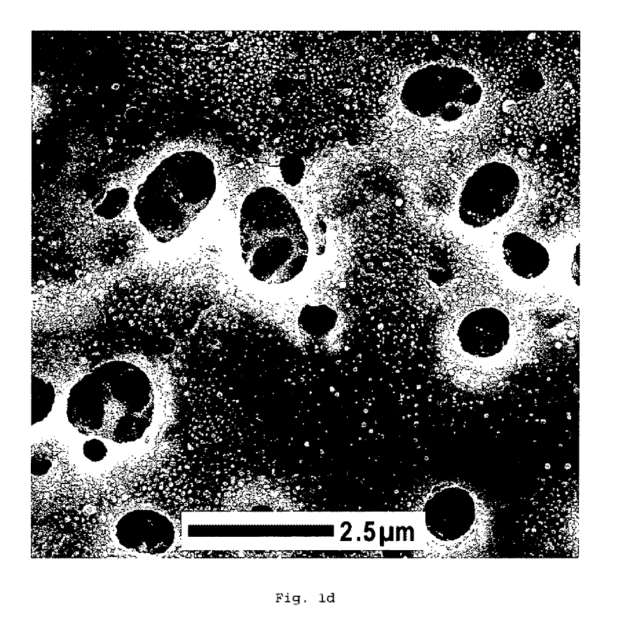

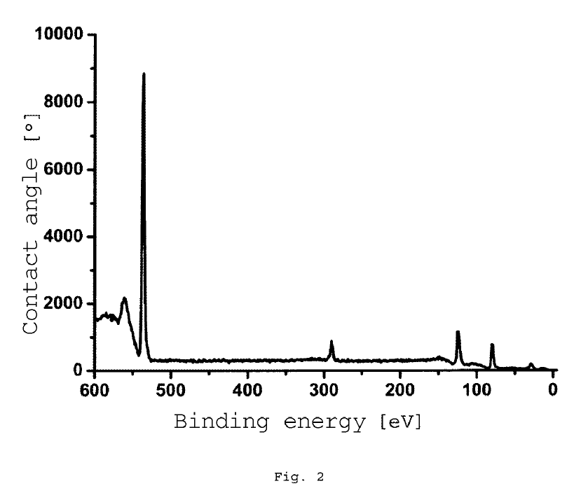

FIG. 3 Micrograph of NHDF stained with antibodies for CD90 in each case: NHDF on glass substrate (a), NHDF on a one-dimensional composite structure of Al/Al₂O₃ without irradiation (b), after one irradiation with one laser pulse (c), with two laser pulses (d) and with three laser pulses (e);

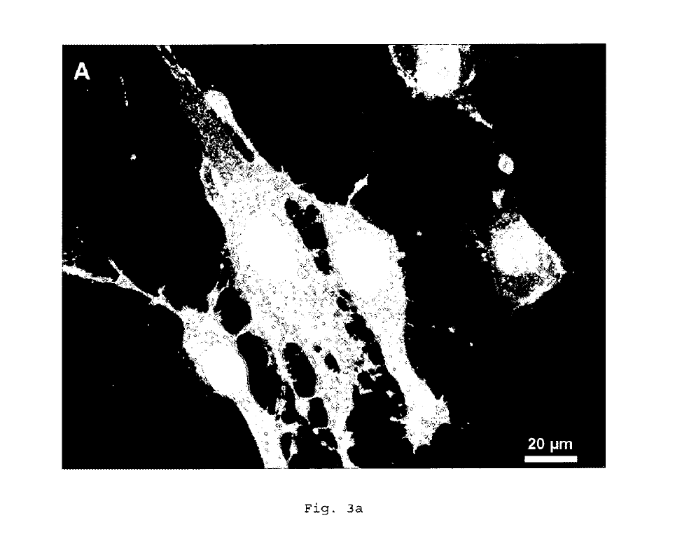

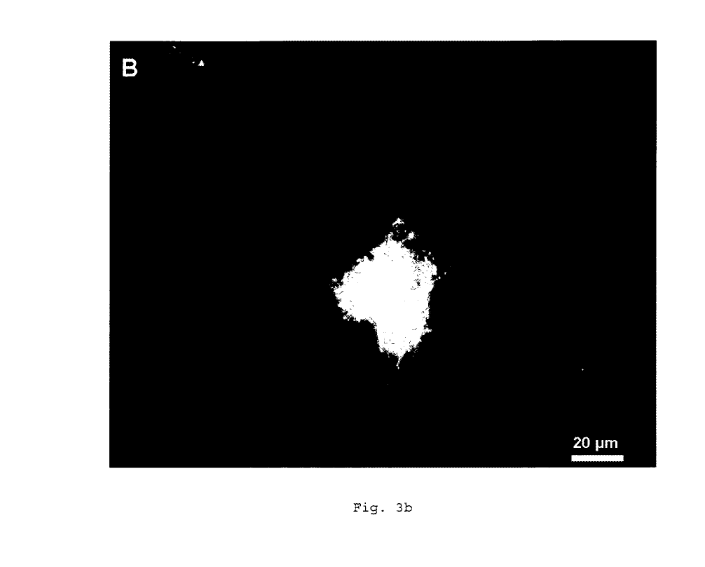

FIG. 4 SEM photo of NHDF cultured on standard glass microscope slides;

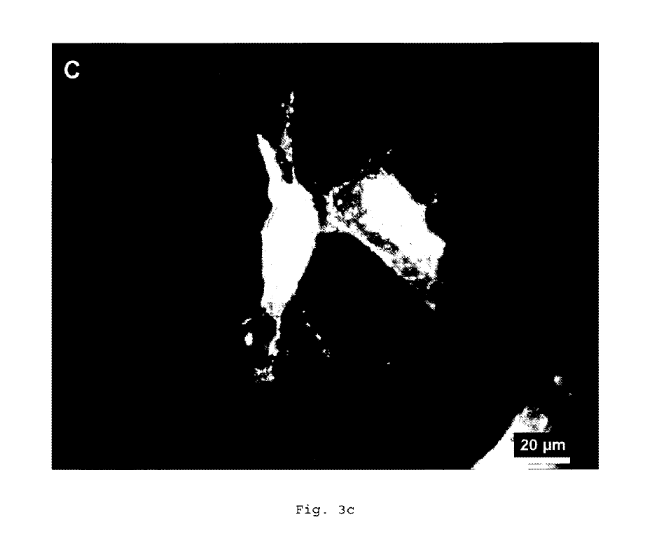

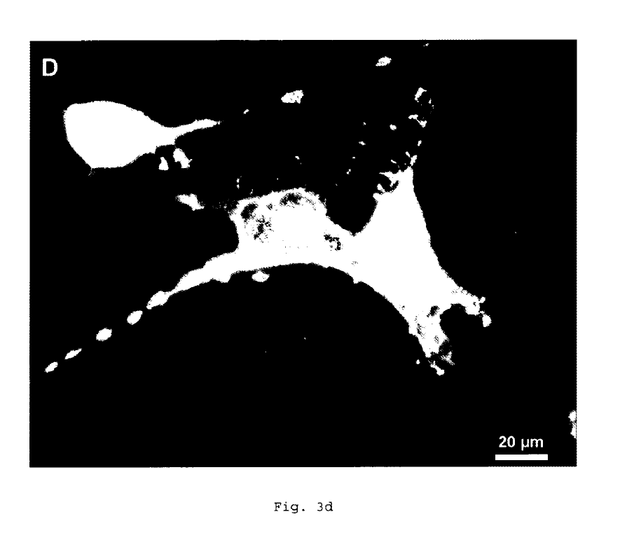

FIG. 5 SEM photos of NHDF cultured on a one-dimensional composite structure of Al/Al₂O₃ without irradiation;

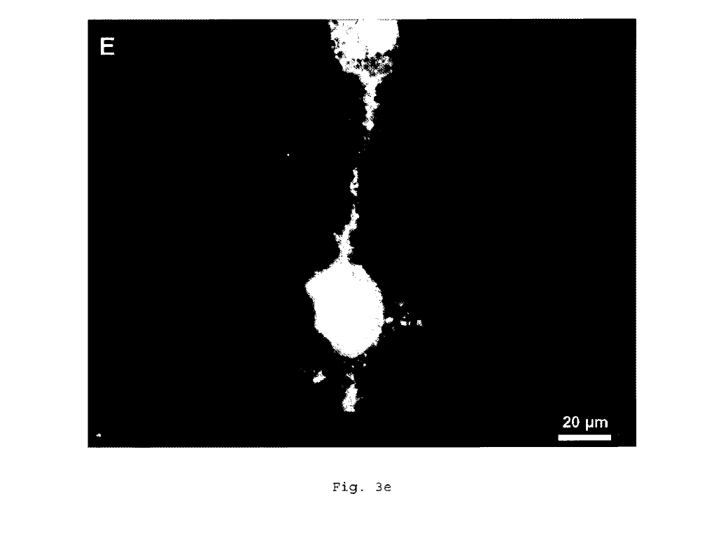

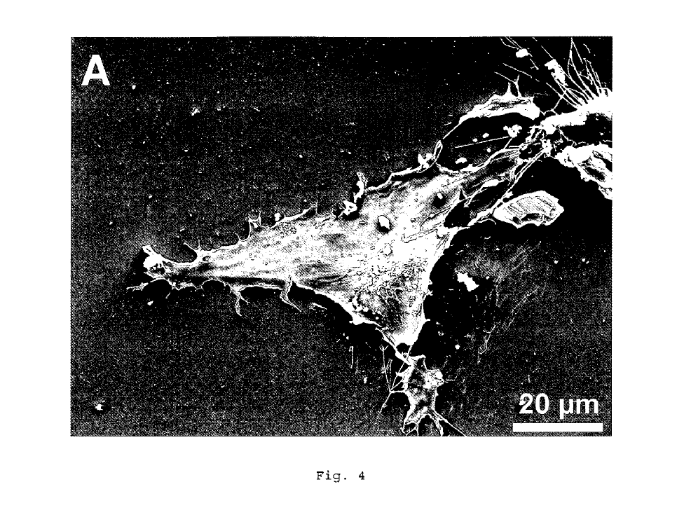

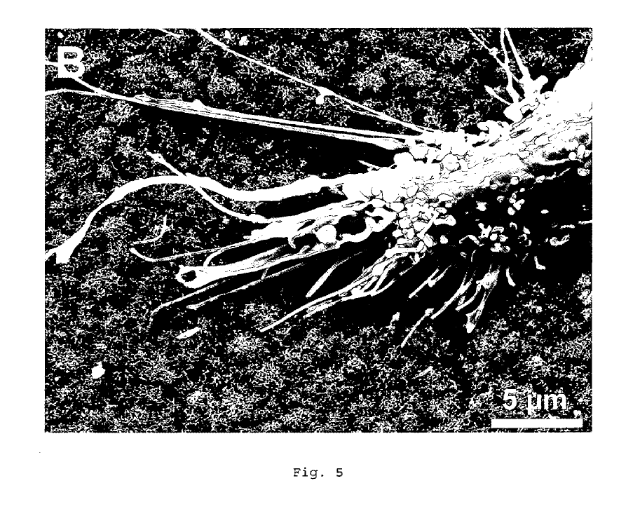

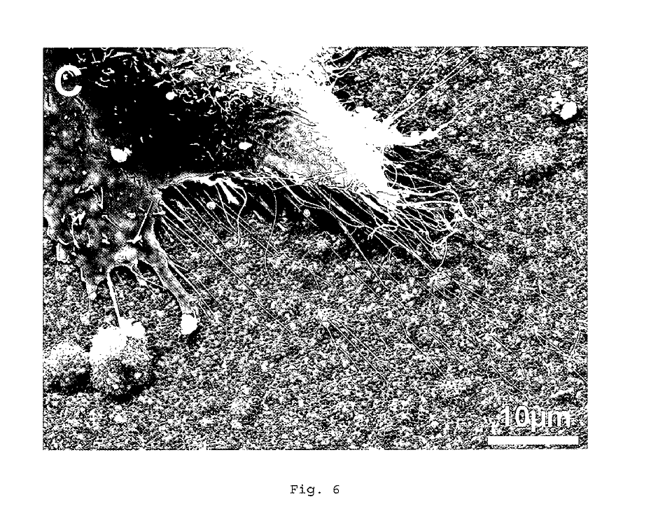

FIG. 6 SEM photo of NHDF cultured on a one-dimensional composite structure of Al/Al₂O₃ after irradiation with one laser pulse;

FIG. 7 SEM photo of NHDF cultured on a one-dimensional composite structure of Al/Al₂O₃ after irradiation with two laser pulses;

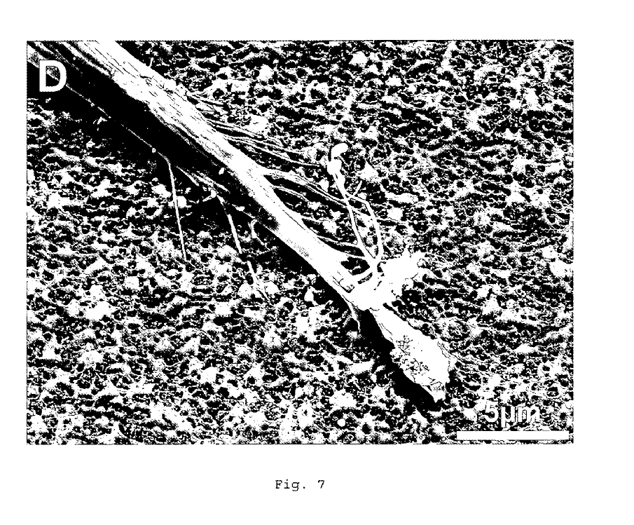

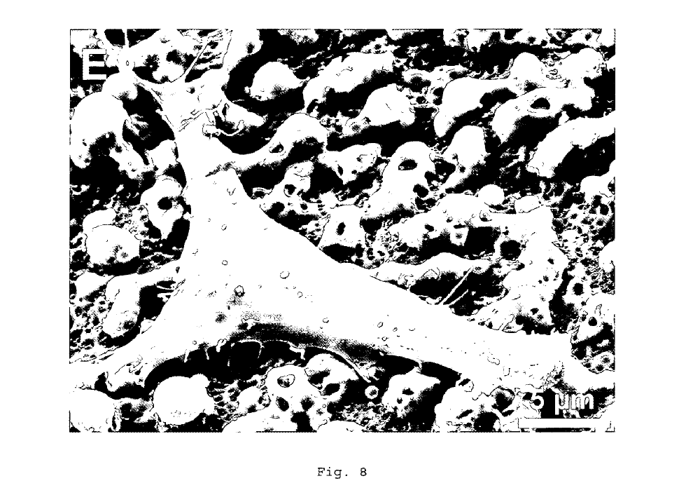

FIG. 8 SEM photo of NHDF cultured on a one-dimensional composite structure of Al/Al₂O₃ after irradiation with three laser pulses; and

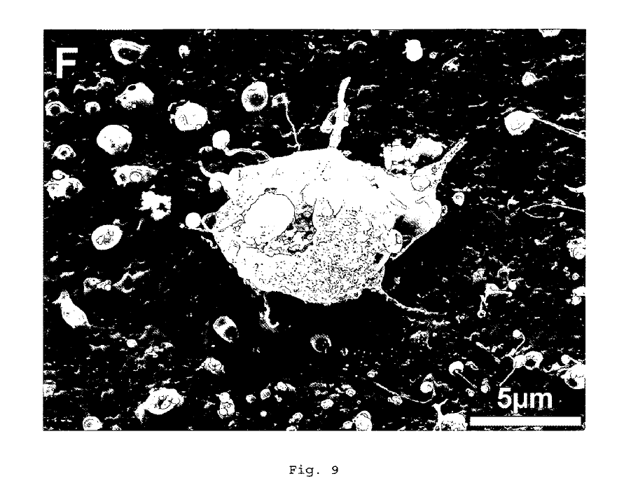

FIG. 9 SEM photos of NHDF cultured on a one-dimensional composite structure of Al/Al₂O₃ after irradiation with three laser pulses;

FIG. 1a shows an SEM picture of a one-dimensional composite structure from thermolytic decomposition of (tBuAlH₂)₂ on glass substrates at 600° C. The nanowires of the one-dimensional composite structure have a uniform diameter of ca. 20-30 nm and consist of an inner core of Al with a coating of Al₂O₃ in the ratio of Al/Al₂O₃=1:1 with a length of several micrometers (Veith M, Sow E, Werner U, Petersen C, Aktas O. The Transformation of Core/Shell Aluminum/Alumina Nano-particles into Nanowires. Eur J Inorg Chem 2008(33); 5181-5184). After a single laser pulse with 0.2 J/cm² in air, the surface changes its color at the irradiation point (from black to white). After a second and a third laser pulse, this color change becomes ever more marked. FIGS. 1b-d show the surface structure of the coating after irradiation with one, two and three laser pulses. After one laser pulse, the surface of the coating seems as if it had melted and again solidified. The solidified material covers the nanostructures lying under it (FIG. 1b). With this surface structure, a few round nanoelevations can be discerned. After a second laser pulse, the surface becomes relatively smooth (FIG. 1c), but a few structures still recall the one-dimensional composite structure lying under it. After one or more further laser pulses, the formation of microparticles on the melted and resolidified layer is observed (FIG. 1d). The size of these larger structures lies in the range from 3 to 5 μm. The coating has a microstructure in the range from 3 to 5 μm.

Important changes are seen on measurement of the contact angle with water as the measurement fluid (FIG. 1). The coating before the irradiation shows a contact angle of about 10°. This value rises to 43° after the irradiation with one laser pulse. This is also an indication of the formation of a structured coating with micro- and nanostructures. On irradiation with a second or third laser pulse, the contact angle falls to 36° and 14° respectively.

The quadratic roughness of a one-dimensional composite structure before the irradiation is about 8.53±0.5 μm. After one laser pulse, this falls to only 4.22±0.2 μm. Further pulses allow this roughness to rise again to 5.12±0.3 μm and 6.37±0.4 μm respectively. This also shows the formation of bulges and grooves on the surface.

An XPS spectrum (Xray photoelectron spectroscopy) of a coating which was irradiated with one laser pulse is shown in FIG. 2. The signals observed derive from the Al2p, Al2s, O1s and C1s electrons. In addition, O (KKL) Auger signals can still be discerned. The C1s signals probably derive from an impurity during the sample preparation or from a pump oil residue. The carbon content remained constant at 5% under all conditions (before and after irradiation). This shows that no carbon-containing layer is formed after the laser irradiation. The chemical composition on the surface shows no change due to the laser irradiation. This was to be expected, since during the oxidation of the aluminum Al₂O₃ is formed, which also already constituted the surface of the coating beforehand.

FIG. 3 shows cell morphologies typically observed on different samples. FIG. 3a shows NHDF as control on a glass plate. In all the fields examined (n=100), 25 mitotic cells could be observed. In contrast to this, the cell density and the number of mitotic cells are markedly reduced on all coated substrates. Thus on the one-dimensional composite structure and the coating treated with one laser pulse, 4 mitotic cells were found, but no mitotic cells on coatings treated with more than one laser pulse. The majority of the cells on the one-dimensional composite structure (not irradiated) shows an unusual cell morphology with a markedly reduced cell size (FIG. 3b). On the coatings treated with one or two laser pulses, the morphology of the cells is similar to the cells on the control substrate glass (FIGS. 3c and 3d respectively). In contrast to this, the cells on the coatings which were treated with three laser pulses are markedly altered. The cells are very small with a small cell nucleus and can scarcely be discerned under the microscope because of their small size and their irregular morphology (FIG. 3e). Studies by AAS showed that no Al³⁺ ions were to be found in the cell culture medium in any of the experiments.

Even on simple microscopic examination, the controls on glass already show a markedly higher cell density than all coated substrates used.

The highest cell density, at 96 cells per square millimeter (cells/mm²), was found on the control substrates of glass. Compared with the initial density of culturing of 63 cells/mm², this is a marked increase and a clear sign of successful cell division. On all other coated substrates, the cell density is drastically reduced. The lowest cell densities of ca. 15 cells/mm² were measured on the one-dimensional composite structure without irradiation and on the coating irradiated with three laser pulses. Compared with this, the coatings which were treated with only one laser pulse exhibit a higher cell density.

By means of SEM, the adhesion of individual cells and the topography of the substrate can also be studied simultaneously. The cells on the glass substrate form many filopodia in order to adhere to the substrate (FIG. 4). Most of the filopodia are very branched and exhibit some elongated regions and broadenings, in order to increase the contact with the surface.

On the one-dimensional composite structure without irradiation, the cells exhibit a rather small and unusual morphology compared with the cells on the glass surface (FIG. 5). Only a few filopodia can be discerned and they are not branched or broadened. Some filopodia seem to have no contact with the surface. In some cases this was even directly visible, since the filopodia moved during the recording with the SEM. In addition, FIG. 5 shows the topography of the one-dimensional composite structure without irradiation, in particular with a secondary structure reminiscent of a raspberry.

The one-dimensional composite structures treated with one laser pulse exhibit an entirely different topography. Most of the nanowires have melted and the raspberry-shaped secondary structure has disappeared. In some pores, the nanostructure can still be discerned (FIG. 6). The morphology of the cells in FIG. 6 is similar to that of the cells in FIG. 4. Many filopodia can be discerned, which are, albeit to a small extent, branched and have broadened regions. The filopodia seem to prefer the smoother regions of the surfaces for adhesion.

The treatment with two laser pulses alters the topography of the surface only slightly (FIG. 7). The cells exhibit a normal morphology and some filopodia can be discerned. Once again the filopodia seem to prefer the smoother regions of the surfaces for adhesion.

After the treatment with three laser pulses, the topography of the surface alters very markedly. The whole surface strewn with spherical particles, which are perhaps formed through the ablation pressure as a consequence of the high energy input of the laser pulse (FIG. 8 and FIG. 9). The cells cultured on this surface are in very poor condition, as can be clearly discerned in FIG. 9. Some cells were able to form filopodia and adhere to the spherical structures (FIG. 8). None the less, these pictures confirm the results from the measurements of cell density.

Material and Methods

Preparation of the one-dimensional composite structure (WO 2008011920 A1; Veith M, Kneip S. New metal-ceramic composites grown by metalorganic chemical-vapor-deposition. J Mater Sci Lett 1994; 13(5): 335-337; Veith M, Faber S, Hempelmann R, Janssen S, Prewo J, Eckerlebe H. Synthesis and microstructure of nano-structured Al/Al₂O₃(H)-composite. Journal of Materials Science 1996: 31(8): 2009-2017)).

Al/Al₂O₃ composite structures were produced by thermolytic decomposition of (tBuOAlH₂)₂ on a glass substrate in a CVD chamber. The method is described in the literature. In summary, the precursor was obtained by reaction of AlCl₃ and LiAlH₄ in tert-butanol. [25]. The substrate was heated to 600° C. and exposed to a constant flow of the precursor at a reduced pressure of 2×10⁻² mbar for 45 minutes. The substrates were then cooled to room temperature under vacuum.

Laser Treatment of the One-Dimensional Composite Structure

The samples were treated with a pulsed Nd:YAG laser (Quanta-Ray PRO 290, Spectra Physics). The wavelength was 532 nm with a pulse length of 8 nsecs and a pulse frequency of 10 Hz. The laser was horizontally polarized and impinged horizontally aligned onto the surface of the samples vertically with no focusing. The number of the pulses (P) was regulated by means of a fast mechanical shutter. The fluence of the laser was 0.2 J/cm². The samples were irradiated with 1 to 3 pulses.

Characterization of the Surface

The treated and untreated samples were examined under an SEM (FEI Quanta 400 FEG) with an accelerating voltage of 10 kV.

The composition of the coating was investigated with a PHI 5600 XPS with monochromatic Al Kα rays.

The contact angle was determined by means of a video system. The samples were placed on a planar table and one drop of distilled water was placed on the samples. The contact angle was determined from the average value of 4 measurements at different places on one sample.

The roughness of the surface was recorded with a profilometer at room temperature. For each sample, 5 profiles were recorded at different places. The quadratic roughness (rms roughness=root mean squared roughness) was determined as the average value of the quadratic roughness of the 5 profiles.

Cell Culture

Unless otherwise stated, normal standard procedures were used for cell culture. The substrates were cleaned by rinsing three times with sterile phosphate-buffered salt solution (PBS), incubation in 70% ethanol for minutes and then rinsing twice with PBS. Fibroblast cells (NHDF, Normal Human Dermal Fibroblasts, Promocell) were cultured in Quantum 333 (Q333, PMA Laboratories) in 75 cm² cell culture bottles (Greiner BioOne) until confluence was reached. For the experiments, only cell cultures which had been transferred less than 10 times were used. The NHDF cells were detached from the base of the cell culture bottles by normal methods. The incubation parameters were 37° C., 95% atmospheric humidity and 5% CO₂. The cell density was determined by means of a CASY® cell counter (Schärfe Systemtechnik). The substrates and standard microscope slides were inoculated with an initial cell density of 63 cells/mm². The incubation was performed in flat dishes (Quadriperm, Greiner BioOne) for 2 days in 4 ml of Q333. One aliquot of the original medium and of the medium after incubation were stored at −20° C. for testing for aluminum ions. The Al³⁺ analysis was performed by atomic absorption spectroscopy (AAS, Quanta). The cell morphology and cell density were documented photographically every day.

Immunofluorescence Labeling

The NHDF were labeled with a constitutive membrane-binding marker for fibroblasts (CD90) in order to determine their morphology by fluorescence spectroscopy.

At the end of the incubation, the medium was removed and the cells (and the substrates) were rinsed three times with PBS (37° C.) and then treated with KCl solution (0.05M) for 5 minutes at 37° C. The cells were fixed by treatment with cold methanol (−20° C.) for at least 10 minutes. After this, the cell membranes were permeabilized by incubating twice with PBS containing 0.05% Tween 20 for 5 minutes. In order to minimize non-specific binding, the substrates were treated with PBS containing 0.1% BSA (bovine serum albumin). As the primary antibody, a mouse-anti-human CD90 antibody (Dianova, Hamburg, 1:200 in PBS containing 0.1% BSA) was added (75 μl). The samples were incubated at room temperature in a dark humid chamber for 30 minutes. After washing three times with PBS containing 0.5% Tween 20, a goat anti-mouse antibody with Cy3 labeling was added as the secondary antibody and also incubated as described above. After this, the samples were washed three times with PBS containing 0.5% Tween 20 and the labeling fixed by incubation with 4% paraformaldehyde in PBS for 5 minutes, and then once again washed with PBS containing 0.5% Tween 20. After dehydration of the samples by multiple treatment with ethanol (70%, 80%, 96%), the samples were stored at 4° C. under mounting medium with 4′,6-diamidino-2-phenylindole (DAPI) for cell labeling (Vectashield, Vector Laboratories) until the microscopic examination was performed.

Microscopic Analysis

The microscopic analyses were performed at 400 times magnification with a Zeiss Axioskop microscope and the Axiovision Software. The cells in 20 fields were counted and the absolute numbers converted into cells per square millimeter. The values obtained were tested for significance (p<0.05) by invariant variance analysis (one-way ANOVA for repeated measures).

SEM Analysis of the Cells

NHDF were cultured as described above. In order to remove the Q333 medium, the substrates were rinsed twice with PBS (37° C.) and fixed with 1% paraform-aldehyde and 1% glutaraldehyde in 0.12M PBS for 2 hours at room temperature and with agitation. The samples were then incubated with osmium tetroxide (4% in deionized water dH₂O) in the dark for 2 hours with agitation. The samples were then kept overnight in dH₂O at 4° C. The cells were dried by twofold treatment in an ethanol concentration series (30%, 50%, 70%, 80% and 90%) at 4° C. for 5 minutes with agitation. The dehydration of the cells was concluded by threefold treatment with 100% ethanol for 15 minutes at 4° C. with agitation. The samples were then dried by critical point drying (Polaron CPD 7501, Quorom Technologies) and sputtered with gold-palladium (Polaron, Sputter Coater). The samples were analyzed in a scanning electron microscope (SEM; FEI XL 30 ESEM FEG SEM, Hilsboro).

### LIST OF CITED LITERATURE

WO 2008011920 A1

Veith M, Faber S, Hempelmann R, Janssen S, Prewo J, Eckerlebe H. Synthesis and microstructure of nanostructured Al/Al2O3(H)-composite. Journal of Materials Science 1996; 31(8):2009-2017

Veith M, Kneip S. New metal-ceramic composites grown by metalorganic chemical-vapor-deposition. J Mater Sci Lett 1994; 13(5):335-337.

Veith M, Sow E, Werner U, Petersen C, Aktas O. The Transformation of Core/Shell Aluminum/Alumina Nanoparticles into Nano-wires. Eur J Inorg Chem 2008(33):5181-5184

Jager M, Zilkens C, Zanger K, Krauspe R. Significance of nano- and microtopography for cell-surface interactions in orthopaedic implants. J Biomed Biotechnol 2007; 2007(8):69036.

Hulbert S F, Young F A, Mathews R S, Klawitter J J, Talbert C D, Stelling F H. Potential of ceramic materials as permanently implantable skeletal prostheses. J Biomed Mater Res 1970; 4(3):433-456.

Webster T, Hellenmeyer E, Price R. Increased osteoblast functions on theta plus delta nanofiber alumina. Biomaterials 2005; 26(9):953-960.

Swan E, Popat K, Grimes C, Desai T. Fabrication and evaluation of nanoporous alumina membranes for osteoblast culture. Journal of Biomedical Materials Research Part A 2005; 72A(3):288-295.

1. A structured coating for the coating of implants, comprising at least one oxide selected from aluminum oxide, gallium oxide, indium oxide and thallium oxide and having a microstructure and/or a nanostructure.

2. A structured coating as claimed in claim 1, wherein the coating exhibits a structuring in the range from 1 to 10 μm.

3. A structured coating as claimed in claim 1, wherein the coating comprises a one-dimensional composite structure.

4. A structured coating as claimed in claim 1, wherein the coating exhibits a contact angle of less than 40°, with water as the measurement liquid.

5. A structured coating as claimed in claim 1, wherein the coating exhibits a quadratic roughness of greater than 5 μm.

6. A structured coating as claimed in claim 1, wherein the coating was obtained by irradiation of a one-dimensional composite structure.

7. A method for the production of a structured coating on a substrate, comprising the following steps:
a) thermolytic decomposition of at least one organometallic compound of the general formula El(OR)H₂, wherein R stands for an aliphatic or alicyclic hydro-carbon residue and El for Al, Ga, In or Tl, at a temperature of more than 400° C. with formation of a composite structure on the substrate; and
b) irradiation of the composite structure.

8. The method as claimed in claim 7, wherein the composite structure is irradiated with a pulsed light source.

9. A structured coating comprising an oxide selected from aluminum oxide, gallium oxide, indium oxide and thallium oxide, wherein the coating has a microstructure in the range from 1 to 10 μm.

10. A structured coating obtainable as claimed in claim 7.

11. A structured coating as claimed in claim 4, wherein the coating exhibits a contact angle of less than 20°, with water as the measurement liquid.

12. A structured coating obtainable as claimed in claim 8.
